(19) United States
(12) Patent Application Publication
(10) Pub. No.: US 2026/0237976 A1
(43) Pub. Date: Aug. 13, 2026

(54) MICROGRID INTERCONNECT DEVICE (MID) AND RETROFITTING SAME INTO EXISTING PANELS

(71) Applicant: Schneider Electric USA, Inc., Andover, MA (US)

(72) Inventor: Chad R. Mittelstadt, Cedar Rapids, IA (US)

(73) Assignee: Schneider Electric USA, Inc., Boston, MA (US)

(21) Appl. No.: 19/050,754

(22) Filed: Feb. 11, 2025

(51) Int. Cl. H02B 1/04; H02B 1/06

(52) U.S. Cl. CPC H02B 1/04; H02B 1/06

(57) ABSTRACT

A method of retrofitting an electrical panel includes removing an interior from a panel housing of the electrical panel. The method includes installing a microgrid interconnect device (MID) into the panel housing into a position formerly occupied by the interior, connecting first and second lines and a neutral line of the panel housing to the MID, and installing the interior onto MID, with the MID between the interior and a back interior surface of the panel housing. The method includes connecting respective busses of the interior to the MID.

### BACKGROUND

### 1. Field

The present disclosure relates to electrical panels, and more particularly to microgrid interconnect devices (MID) for connecting and disconnecting residential electrical panels such as common service entrance device (CSED) panels from utility grids.

### 2. Description of Related Art

It is common for CSED panels to need an MID, but there is no provision to add an MID to a CSED panel easily. One solution has been to locate an MID inside the meter collar, but that is location is not always compliant with utility regulations. Ideally, there would be enough room in the CSED panel itself to locate an MID physically in between the main breaker and the interior. However in legacy CSED configurations there is not enough room in the vertical direction to fit an MID physically. While there are some new install options for accommodating MID's in CSED panels, they do not solve the problem of retrofitting legacy CSED panels to include MID's. Existing retrofit solutions require relocating the branch breakers, which is not ideal.

The conventional techniques have been considered satisfactory for their intended purpose. However, there is an ever-present need for improved systems and methods for incorporating MID's with CSED panels, including methods for retrofitting legacy CSED panels to include MID's. This disclosure provides a solution for this need.

### SUMMARY

A method of retrofitting an electrical panel includes removing an interior from a panel housing of the electrical panel. The method includes installing a microgrid interconnect device (MID) into the panel housing into a position formerly occupied by the interior, connecting first and second lines and a neutral line of the panel housing to the MID, and installing the interior onto MID, with the MID between the interior and a back interior surface of the panel housing. The method includes connecting respective busses of the interior to the MID.

Prior removing the interior from the panel housing, the method can include unplugging a plurality of branch devices from the buses of the interior. After installing the interior onto the MID, the method can include re-installing the branch devices to the busses of the interior. Prior removing the interior from the panel housing, the method can include removing a deadfront from the panel housing to provide access to an interior of the electrical panel. After connecting respective busses of the interior to the MID, the method can include re-installing the deadfront or installing a new deadfront to the panel housing. The method can include connecting an external device a communication port of the MID.

A microgrid interconnect device (MID) includes a switching device. A first line connector is electrically connected to the switching device and is configured to connect to a first line of an electrical panel. A second line connector is electrically connected to the switching device and is configured to connect to a second line of the electrical panel. A first load connector is electrically connected to the switching device and is configured to connect to a first line bus of an interior of the electrical panel, e.g. through a main breaker. A second load connector is electrically connected to the switching device and is configured to connect to a second line bus of the interior, e.g. through a main breaker. The switching device is configured to switch back and forth between an ON state and an OFF state. In the ON state, the switching device electrically connects the first line connector to the first load connector and electrically connects the second line connector to the second load connector. In the OFF state, the switching device electrically isolates the first line connector from the first load connector and electrically isolates the second line connector from the second load connector.

A housing can be included. The switching device can be in an interior space of the housing. Each of the first load connector, the second load connector, the first line connector, and the second line connector can extend from an exterior space, through the housing, and into the interior space of the housing. A neutral line connector can be mounted to the housing. The neutral line connector can be configured to connect to a neutral line of the electrical panel to a neutral bus of the interior. The housing can include a back surface at a first elevation in a z-direction defined perpendicular to the back surface. Respective terminals of the first and second line connectors can be positioned at a second elevation in the z-direction spaced apart from the first elevation. Terminals of the first and second load connectors can be positioned at a third elevation in the z-direction farther from the first elevation that is the second elevation. The neutral line connector can extend from a fourth elevation in the z-direction to a fifth elevation in the z-direction. The housing can have a thickness in the z-direction of about, e.g., 33 mm, width lateral to the z-direction of about, e.g., 180 mm, and a length lateral to the width and to the z-direction of about, e.g., 500 mm, wherein the housing has a thickness in the z-direction, width lateral to the z-direction, and a length lateral to the width and to the z-direction, e.g., with an aspect ratio of the thickness to the length being about 35/500 or less.

A printed circuit board assembly (PCBA) can be within the interior space of the housing. The PCBA can include a controller configured to control the switching device to switch the switching device back and forth between the ON and OFF states. A first sensor can be operatively connected to feedback signals indicative of current in the first load connector to the controller for feedback based control of the switching device. A second sensor can be operatively connected to feedback signals indicative of current in the second load connector to the controller for feedback based control of the switching device. At least one communication port can be included. The at least one communication port can be configured for connection to devices outside of the housing. The at least one communication port can be operatively connected to the PCBA for data exchange between the PCBA and an external device.

An electrical panel includes a panel housing defining a back interior surface and including a first line and a second line. An interior in the panel housing. A microgrid interconnect device (MID) in the panel housing between the interior and the back interior surface, wherein the MID is connected in electrical series between the interior and the first and second lines in of the panel housing.

A plurality of branch devices can be operatively connected to the interior to control individual circuits respectively connected to the branch devices by respective load wires. The MID can include a switching device. A first line connector can be electrically connected to the switching device and to the first line of the panel housing. A second line connector can be electrically connected to the switching device and to the second line of the panel housing. A first load connector can be electrically connected to the switching device and to connect to a first line bus of the interior. A second load connector can be electrically connected to the switching device and to a second line bus of the interior. The switching device can be configured to switch back and forth between an ON state and an OFF state. In the ON state, the switching device can electrically connect the first line connector to the first load connector and can electrically connect the second line connector to the second load connector. In the OFF state, the switching device can electrically isolate the first line connector from the first load connector and can electrically isolate the second line connector from the second load connector.

An MID housing can be included. The switching device can be in an interior space of the MID housing. Each of the first load connector, the second load connector, the first line connector, and the second line connector can extend from an exterior space, through the MID housing, and into the interior space of the MID housing. A neutral line connector can be mounted to the MID housing and can be electrically connected to a neutral line of the panel housing and to a neutral bus of the interior. The MID housing can include a back surface at a first elevation in a z-direction defined perpendicular to the back surface. Respective terminals of the first and second line connectors can be positioned at a second elevation in the z-direction spaced apart from the first elevation. Terminals of the first and second load connectors can be positioned at a third elevation in the z-direction farther from the first elevation that is the second elevation. The neutral line connector can extend from a fourth elevation in the z-direction to a fifth elevation in the z-direction.

A printed circuit board assembly (PCBA) can be included within the interior space of the MID housing. The PCBA can include a controller configured to control the switching device to switch the switching device back and forth between the ON state and the OFF state. A first sensor can be operatively connected to feedback signals indicative of current in the first load connector to the controller for feedback based control of the switching device. A second sensor can be operatively connected to feedback signals indicative of current in the second load connector to the controller for feedback based control of the switching device. At least one communication port can be configured for connection to devices outside of the MID housing. The at least one communication port can be operatively connected to the PCBA for data exchange between the PCBA and an external device.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic perspective view of an embodiment of an electrical panel for retrofitting in accordance with the present disclosure, showing the panel housing and deadfront prior to retrofitting to include a microgrid interconnect device (MID);

FIG. 2 is a schematic perspective view of the electrical panel of FIG. 1, showing the deadfront and interior removed from the panel housing;

FIG. 3 is a is a schematic perspective view of the electrical panel of FIG. 2, showing the MID mounted in the panel housing;

FIG. 4 is a schematic perspective view of the MID of FIG. 3, showing the internal components inside the MID housing;

FIG. 5 is a schematic perspective view of the MID of FIG. 3, showing the connectors of the MID;

FIG. 6 is a schematic perspective view of the electrical panel of FIG. 3, showing the interior installed over the MID;

FIG. 7 is a schematic perspective view of the electrical panel of FIG. 6, showing the branch devices reinstalled on the interior;

FIG. 8 is a schematic perspective view of the electrical panel of FIG. 7, showing connection of the communication port or ports of the MID to the panel housing for data connection to external devices; and

FIG. 9 is a schematic perspective view of the electrical panel of FIG. 8, showing a deadfront mounted over the interior to enclose the interior and MID inside the panel housing.

### DETAILED DESCRIPTION OF THE PREFERRED EMBODIMENTS

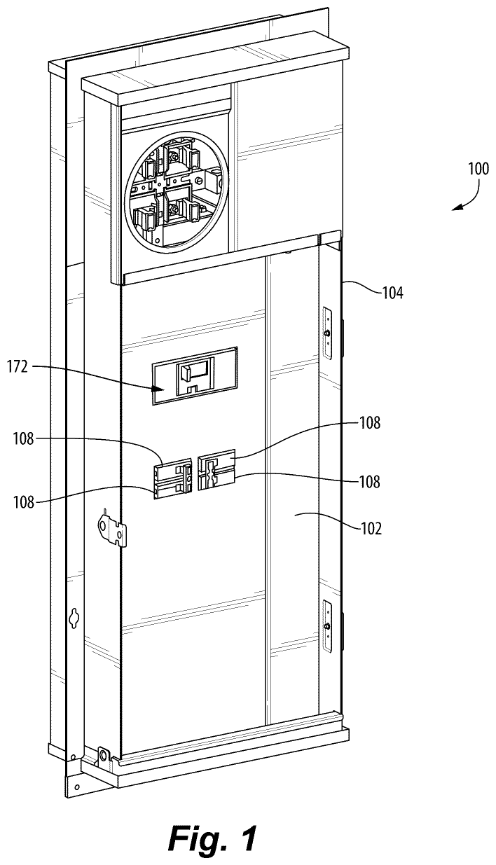

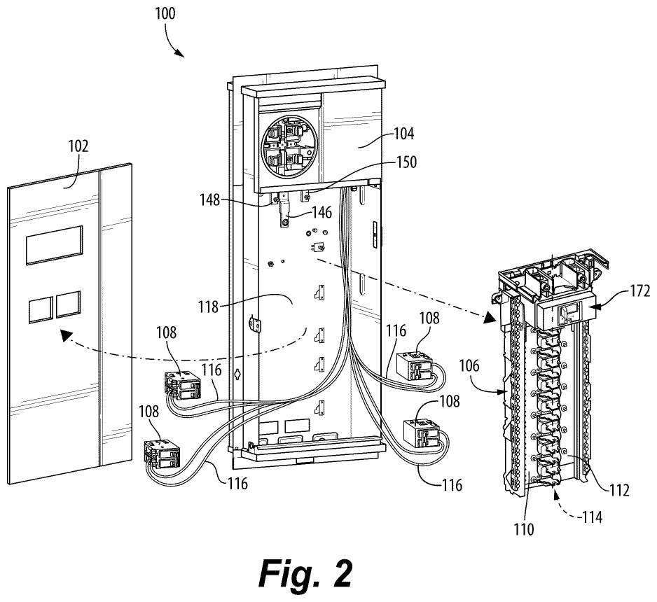

Reference will now be made to the drawings wherein like reference numerals identify similar structural features or aspects of the subject disclosure. For purposes of explanation and illustration, and not limitation, a partial view of an embodiment of an electrical panel for retrofitting in accordance with the disclosure is shown in FIG. 1 and is designated generally by reference character 100. Other embodiments of systems in accordance with the disclosure, or aspects thereof, are provided in FIGS. 2-9, as will be described. The systems and methods described herein can be used to retrofit legacy electrical panels such as common service entrance device (CSED) panels, indoor/outdoor load centers, or the like, to include a microgrid interconnect device (MID).

A method of retrofitting an electrical panel 100 can start with an electrical panel 100 such as a Square D CSED panel, an indoor/outdoor load center, or the like, as shown in FIG. 1. As shown in FIG. 2, the method includes removing a legacy deadfront 102 from the electrical panel housing 104 to provide access to an interior 106 of the electrical panel 100, as indicated by the large, left-pointing arrow in FIG. 2. The method includes unplugging a plurality of branch devices 108, e.g. circuit breakers, from the buses 110, 112, 114 of the interior 106, e.g. letting the branch devices 108 hang by their load wires 116 off to the side of the back interior surface 118 of the panel housing 104. The method includes removing the interior 106 from the panel housing 104 as indicated by the large right-pointing arrow in FIG. 2.

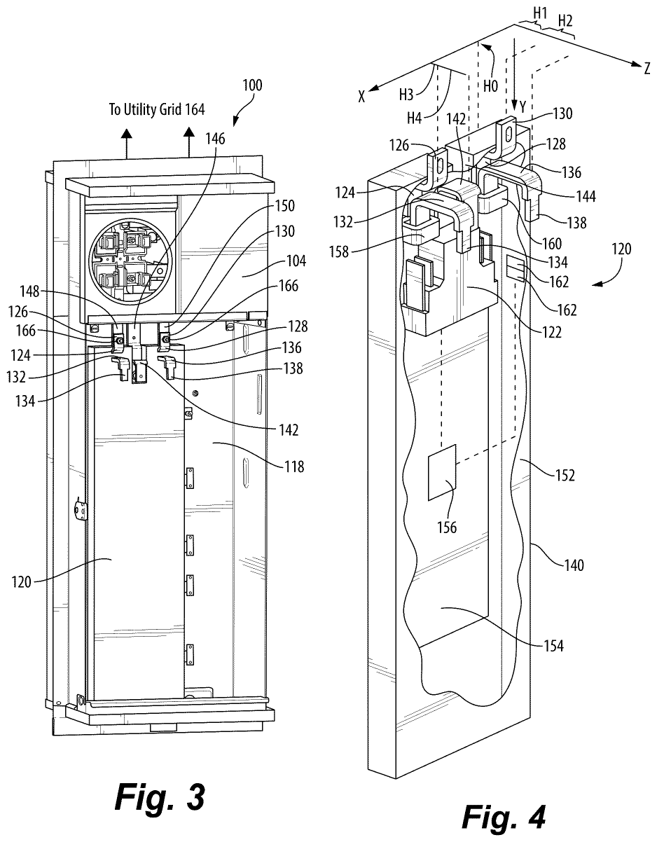

With reference now to FIG. 3, the method includes installing a microgrid interconnect device (MID) 120 into the panel housing 104 into a position formerly occupied by the interior 106. As shown in FIG. 4, the MID 120 includes a switching device 122, e.g. a 200A relay. A first line connector 124 is electrically connected to the switching device 122. A second line connector 128 is electrically connected to the switching device 122. A first load connector 132 is electrically connected to the switching device 122. A second load connector 136 is electrically connected to the switching device 122. The switching device 122 is configured to switch back and forth between an ON state and an OFF state. In the ON state, the switching device 122 electrically connects the first line connector 124 to the first load connector 132 and electrically connects the second line connector 128 to the second load connector 136. In the OFF state, the switching device 122 electrically isolates the first line connector 124 from the first load connector 132 and electrically isolates the second line connector 128 from the second load connector 136.

With continued reference to FIGS. 3-4, the MID 120 includes an MID housing 140. The switching device 122 is in an interior space of the housing 140. Each of the first line connector 124, and the second line connector 128, the first load connector 132, the second load connector 136, extends from an exterior space, through a wall of the housing 140, and into the interior space of the housing 140. A neutral line connector 142 is mounted to the housing 140 in a notch 144 of the housing 140 between the first and second load connectors 132, 136.

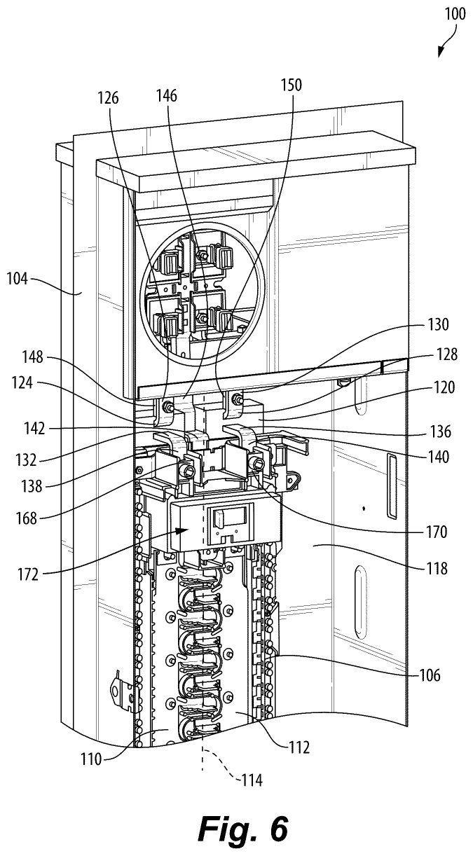

With reference to FIG. 4, the housing 140 includes a back surface 152 at an elevation H0 in a z-direction defined perpendicular to the back surface 152, e.g. H0=0. Respective terminals 126, 130 of the first and second line connectors 124, 128 are positioned at a first elevation H1 in the z-direction spaced apart from the elevation H0. Terminals 134, 138 of the first and second load connectors 132, 136 are positioned at an elevation H2 in the z-direction farther from the elevation H0 of the back surface 152 that is the elevation H1. The neutral line connector 142 extends from an elevation H3 in the z-direction to an elevation H4 in the z-direction that is farther from the back surface 152 than is the elevation H3. This elevation H2 above the elevation H1 and of elevation H4 above elevation H3 allows for the elevation of the interior 106 when it is reinstalled as described below with reference to FIG. 6 relative to its original elevation before retrofitting.

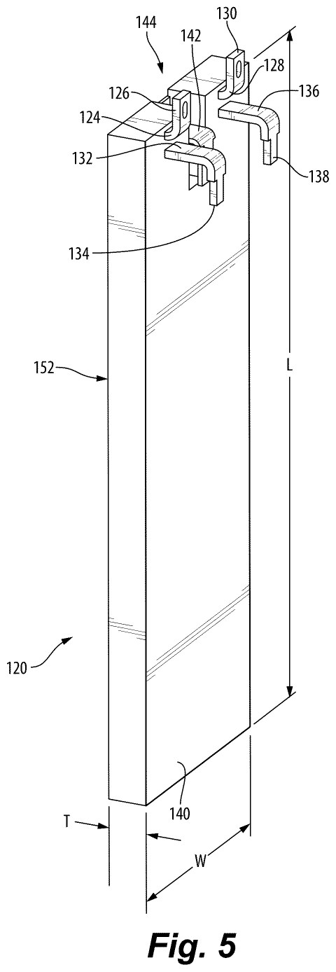

With reference to FIG. 5, the housing 140 has a thickness T in the z-direction of about, e.g., 33 mm, a width W lateral to the z-direction of about, e.g., 180 mm, and a length L lateral to the width W and to the z-direction of about, e.g., 500 mm. The housing 140 has an aspect ratio of the thickness to the length being about 35/500 or less. This envelope accommodates the MID 120 in the space described below between the panel housing 104 and the interior 106 after the retrofit for a CSED. Legacy CSEDs are deep enough in the z-direction to allow an elevated interior 106. Those skilled in the art will readily appreciate that any suitable dimensions can be used, and that an MID as disclosed herein can be modified in envelop as needed to fit any suitable electrical panel as needed.

Referring again to FIG. 4, a printed circuit board assembly (PCBA) 154 is included within the interior space of the housing 140. The PCBA 154 includes a controller 156 operatively connected to control the switching device 122 to switch the switching device 122 back and forth between the ON and OFF states. A first current sensor 158 is operatively connected to feedback signals indicative of current in the first load connector 132 to the controller 156 for feedback based control of the switching device 122. A second current sensor 160 is operatively connected to feedback signals indicative of current in the second load connector 136 to the controller 156 for feedback based control of the switching device 122. At least one communication port 162 is included, operatively connected for data input/output of the PCBA 154 and controller 156, e.g., for uploading commands and/or programming into the PCBA 154 for the controller 156, downloading usage data or the like from the PCBA 154. The at least one communication port 162 is mounted to an opening in the housing 140 for connection to external devices outside of the housing 140. In addition, state feedback, e.g. from internal microswitches or the like, from the switching device 122 can be connected to the PCBA 154 to make the state of the switching device 122 known to the PCBA 154.

With reference again to FIG. 3, the method includes connecting first and second lines 148, 150 of the panel housing 104 and a neutral line 146 of the panel housing 104 to the MID 120. The lines 148, 150, in turn connect to a utility grid 164. The terminal 126 of the first line connector 124 is electrically and mechanically connected to a first line 148 of an electrical panel, e.g. with a fastener 166. A terminal 130 of the second line connector 128 of the MID 120 is electrically and mechanically connected to the second line 150 of the electrical panel 100, e.g.

with a fastener 166.

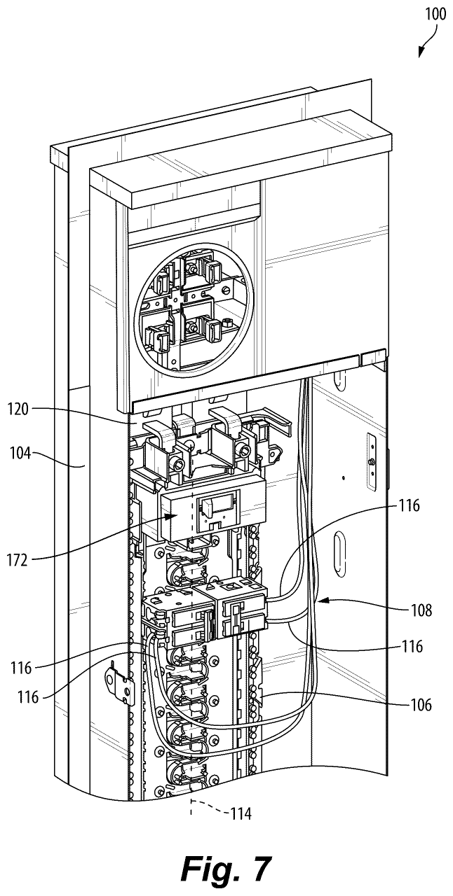

With reference to FIG. 6, the method includes installing the interior 106 onto MID 120, with the MID 120 physically located between the interior 106 and a back interior surface 118 of the panel housing 104. The method includes connecting respective busses 110, 112, 114 of the interior 106 to the MID 120, so the MID 120 is connected in electrical series between the busses 110, 112, 114 of the interior 106 and the first, second, and neutral lines 148, 150, 146 in of the panel housing 104, respectively. A terminal 134 of the first load connector 132 is electrically and mechanically connected to the first line bus 110 of the interior 106, e.g. using a lug 168 of the interior 106. The first line connector 124 thereby electrically connects the switching device 122 to the first line 148 of the panel housing 104, and to the first line bus 110 when the switching device 122 is in the ON state. A terminal 138 of the second load connector 136 is mechanically and electrically connected to the second line bus 112 of the interior 106, e.g. using the lug 170 of the interior 106. The second line connector 128 thereby electrically connects the switching device 122 to the second line 150 of the panel housing 104, and to the second line bus 112 when the switching device 122 is in the ON state. The neutral line connector 142 is connected to a neutral line 146 of the electrical panel 100 and to the neutral bus 114 of the interior 106, e.g. for grounding respective circuits of the branch devices 108 of FIG. 7.

With reference now to FIG. 7, after installing the interior 106 onto the MID 120, the method includes re-installing the branch devices 108 to the busses 110, 112, 114 of the interior 106, e.g. without ever having to disconnect or reconnect the branch devices 108 from the respective wires 116. The plurality of branch devices 108 thereby operatively connected to the interior 106 to control individual circuits respectively connected to the branch devices 108 by respective load wires 116, not labeled in FIG. 7. The interior 106 includes a main switching device or breaker 172. The MID 120 is connected in electrical series between the first and second lines 148, 150 of the electrical panel 100 and the main breaker 172 of the interior 106.

The main breaker 172 is in electrical series between the first and second load connectors 132, 136 and the first and second line busses 110, 112, respectively. This allows the MID 120 to disconnect the electrical panel from the utility grid 164 (labeled in FIG. 3), and still have the circuit breaking capability of the main breaker 172 for protecting the circuits connected to the branch devices 108 as a whole, e.g. when operating the interior 106 as an island separate from the utility grid 164.

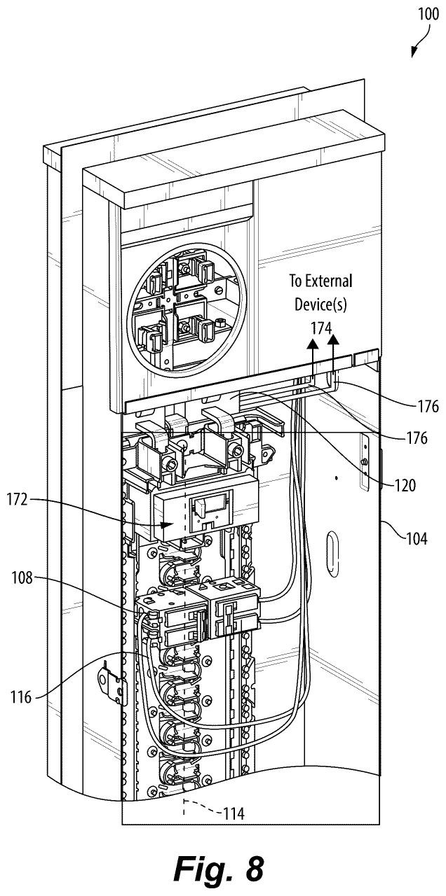

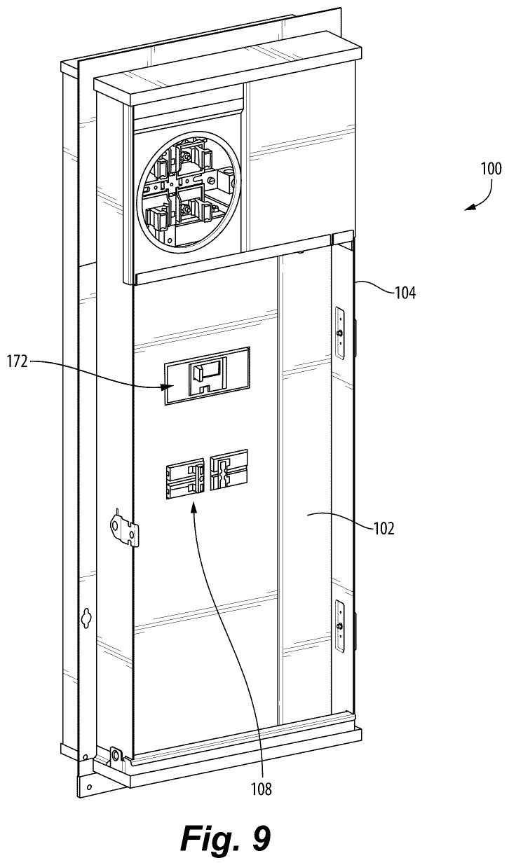

Referring now to FIG. 8, the method includes connecting an external device 174 to the at least one communication port 162 of the MID 120 (labeled in FIG. 4), e.g. using respective cables 176 for Ethernet, RS485, auxiliary, or the like. After connecting respective busses 110, 112, 114 of the interior 106 to the MID 120 and re-installing the branch devices 108 to the busses 110, 112, 114 of the interior 106 as described above, the method includes re-installing the deadfront 102 or installing a new deadfront 102 to the panel housing 104, as shown in FIG. 9.

The methods and systems of the present disclosure, as described above and shown in the drawings, provide for retrofitting legacy electrical panels such as common service entrance device (CSED) panels, indoor/outdoor load centers, or the like, to include a microgrid interconnect device (MID). While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A method of retrofitting an electrical panel comprising:
removing an interior from a panel housing of the electrical panel;
installing a microgrid interconnect device (MID) into the panel housing into a position formerly occupied by the interior;
connecting first and second lines and a neutral line of the panel housing to the MID;
installing the interior onto MID, with the MID between the interior and a back interior surface of the panel housing; and
connecting respective busses of the interior to the MID.

2. The method as recited in claim 1, further comprising:
prior removing the interior from the panel housing, unplugging a plurality of branch devices from the buses of the interior; and
after installing the interior onto the MID, re-installing the branch devices to the busses of the interior.

3. The method as recited in claim 1, further comprising connecting an external device a communication port of the MID.

4. The method as recited in claim 1, further comprising:
prior to removing the interior from the panel housing, removing a deadfront from the panel housing to provide access to an interior of the electrical panel; and
after connecting respective busses of the interior to the MID, re-installing the deadfront or installing a new deadfront to the panel housing.

5. A microgrid interconnect device (MID) comprising:
a switching device;
a first line connector electrically connected to the switching device and configured to connect to a first line of an electrical panel;
a second line connector electrically connected to the switching device and configured to connect to a second line of the electrical panel;
a first load connector electrically connected to the switching device; and
a second load connector electrically connected to the switching device;
wherein the switching device is configured to switch back and forth between an ON state and an OFF state,
wherein in the ON state, the switching device electrically connects the first line connector to the first load connector and electrically connects the second line connector to the second load connector, and
wherein in the OFF state, the switching device electrically isolates the first line connector from the first load connector and electrically isolates the second line connector from the second load connector.

6. The MID as recited in claim 5, further comprising a housing, wherein the switching device is in an interior space of the housing, wherein each of the first load connector, the second load connector, the first line connector, and the second line connector extends from an exterior space, through the housing, and into the interior space of the housing.

7. The MID as recited in claim 6, further comprising a neutral line connector mounted to the housing configured to connect to a neutral line of the electrical panel to a neutral bus of the interior.

8. The MID as recited in claim 7, wherein the housing includes a back surface at a first elevation in a z-direction defined perpendicular to the back surface, wherein respective terminals of the first and second line connectors are positioned at a second elevation in the z-direction spaced apart from the first elevation, wherein terminals of the first and second load connectors are positioned at a third elevation in the z-direction farther from the first elevation that is the second elevation, and wherein the neutral line connector extends from a fourth elevation in the z-direction to a fifth elevation in the z-direction.

9. The MID as recited in claim 7, wherein the housing has a thickness in the z-direction, width lateral to the z-direction, and a length lateral to the width and to the z-direction, with an aspect ratio of the thickness to the length being about 35/500 or less.

10. The MID as recited in claim 7, further comprising:
a printed circuit board assembly (PCBA) within the interior space of the housing, wherein the PCBA includes a controller configured to control the switching device to switch the switching device back and forth between the ON state and the OFF state;
a first sensor operatively connected to feedback signals indicative of current in the first load connector to the controller for feedback based control of the switching device; and
a second sensor operatively connected to feedback signals indicative of current in the second load connector to the controller for feedback based control of the switching device.

11. The MID as recited in claim 10, further comprising at least one communication port configured for connection to devices outside of the housing, wherein the at least one communication port is operatively connected to the PCBA for data exchange between the PCBA and an external device.

12. An electrical panel comprising:
a panel housing defining a back interior surface and including a first line and a second line;
an interior in the panel housing; and
a microgrid interconnect device (MID) in the panel housing between the interior and the back interior surface, wherein the MID is connected in electrical series between the interior and the first and second lines in of the panel housing.

13. The electrical panel as recited in claim 12, further comprising a plurality of branch devices operatively connected to the interior to control individual circuits respectively connected to the branch devices by respective wires.

14. The electrical panel as recited in claim 12, wherein the MID includes:
a switching device;
a first line connector electrically connected to the switching device and to the first line of the panel housing;
a second line connector electrically connected to the switching device and to the second line of the panel housing;
a first load connector electrically connected to the switching device and to a first line bus of the interior; and
a second load connector electrically connected to the switching device and to a second line bus of the interior;
wherein the switching device is configured to switch back and forth between an ON state and an OFF state,
wherein in the ON state, the switching device electrically connects the first line connector to the first load connector and electrically connects the second line connector to the second load connector, and
wherein in the OFF state, the switching device electrically isolates the first line connector from the first load connector and electrically isolates the second line connector from the second load connector.

15. The electrical panel as recited in claim 14, further comprising an MID housing, wherein the switching device is in an interior space of the MID housing, wherein each of the first load connector, the second load connector, the first line connector, and the second line connector extends from an exterior space, through the MID housing, and into the interior space of the MID housing.

16. The electrical panel as recited in claim 15, further comprising a neutral line connector mounted to the MID housing and electrically connected to a neutral line of the panel housing and to a neutral bus of the interior.

17. The electrical panel as recited in claim 16, wherein the MID housing includes a back surface at a first elevation in a z-direction defined perpendicular to the back surface, wherein respective terminals of the first and second line connectors are positioned at a second elevation in the z-direction spaced apart from the first elevation, wherein terminals of the first and second load connectors are positioned at a third elevation in the z-direction farther from the first elevation that is the second elevation, and wherein the neutral line connector extends from a fourth elevation in the z-direction to a fifth elevation in the z-direction.

18. The electrical panel as recited in claim 16, wherein the MID housing has a thickness in the z-direction, width lateral to the z-direction, and a length lateral to the width and to the z-direction, with an aspect ratio of the thickness to the length being about 35/500 or less.

19. The electrical panel as recited in claim 16, further comprising:
a printed circuit board assembly (PCBA) within the interior space of the MID housing, wherein the PCBA includes a controller configured to control the switching device to switch the switching device back and forth between the ON state and the OFF state;
a first sensor operatively connected to feedback signals indicative of current in the first load connector to the controller for feedback based control of the switching device; and
a second sensor operatively connected to feedback signals indicative of current in the second load connector to the controller for feedback based control of the switching device.

20. The electrical panel as recited in claim 19, further comprising at least one communication port configured for connection to devices outside of the MID housing, wherein the at least one communication port is operatively connected to the PCBA for data exchange between the PCBA and an external device.
